(19) United States
(12) Patent Application Publication
(10) Pub. No.: US 2024/0057173 A1
(43) Pub. Date: Feb. 15, 2024

(54) METHOD, DEVICE, AND SYSTEM FOR SMALL DATA TRANSMISSION IN WIRELESS NETWORKS

(71) Applicant: ZTE Corporation, Shenzhen (CN)

(72) Inventors: Yu LIU, Shenzhen (CN); He HUANG, Shenzhen (CN)

(73) Assignee: ZTE Corporation, Shenzhen (CN)

(21) Appl. No.: 18/345,111

(22) Filed: Jun. 30, 2023

Related U.S. Application Data
(63) Continuation of application No. PCT/CN2021/071027, filed on Jan. 11, 2021.

(51) Int. Cl. H04W 74/08; H04W 24/04

(52) U.S. Cl. CPC H04W 74/0833; H04W 24/04

(57) ABSTRACT

This disclosure describes a method and system for small data transmission of various types. Performed by a User Equipment (UE) in a wireless network, the method including: receiving a first message from a wireless communication node in the wireless network comprising at least one of the following parameters for the wireless terminal to configure a small data transmission (SDT): a scheduling request configuration parameter; a random access channel configuration parameter; a paging parameter; or a Discontinuous Reception (DRX) parameter; and when the wireless terminal is in an inactive state, initiating an SDT session by sending an SDT initiation message to the wireless communication node on a preconfigured resource allocated by configured grant (CG).

### TECHNICAL FIELD

This disclosure is directed generally to wireless communications, and particularly to a method, device, and system for small data transmission.

### BACKGROUND

A wireless network supports various types of services having different requirements for data packet transmission. These requirements include, for example, payload size, transmission latency, transmission reliability, transmission priority, and the like. When a User Equipment (UE) is in inactive mode, it is critical to for the UE to reduce power consumption while supporting data transmission with low signaling overhead.

### SUMMARY

This disclosure is directed to a method, device, and system for small data transmission of various types in wireless communications.

In embodiment, a method performed by a wireless terminal in a wireless network is disclosed. The method may include receiving a first message from a wireless communication node in the wireless network comprising at least one of the following parameters for the wireless terminal to configure a small data transmission (SDT): a scheduling request configuration parameter; a random access channel configuration parameter; a paging parameter; or a Discontinuous Reception (DRX) parameter; and when the wireless terminal is in an inactive state, initiating an SDT session by sending an SDT initiation message to the wireless communication node on a preconfigured resource allocated by configured grant (CG).

In another embodiment, a method performed by a wireless communication node in a wireless network is disclosed. The method may include receiving a first message from a core network of the wireless network indicative a paging request to page a wireless terminal in the wireless network, the wireless terminal being in an SDT session with the wireless communication node; and sending a second message to the wireless terminal.

In some embodiments, there is a wireless communication device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example wireless communication network.

FIG. 2 shows an example small data transmission procedure with error recovery.

FIG. 3 shows example multiple step random access procedures.

### DETAILED DESCRIPTION

### Wireless Communication Network

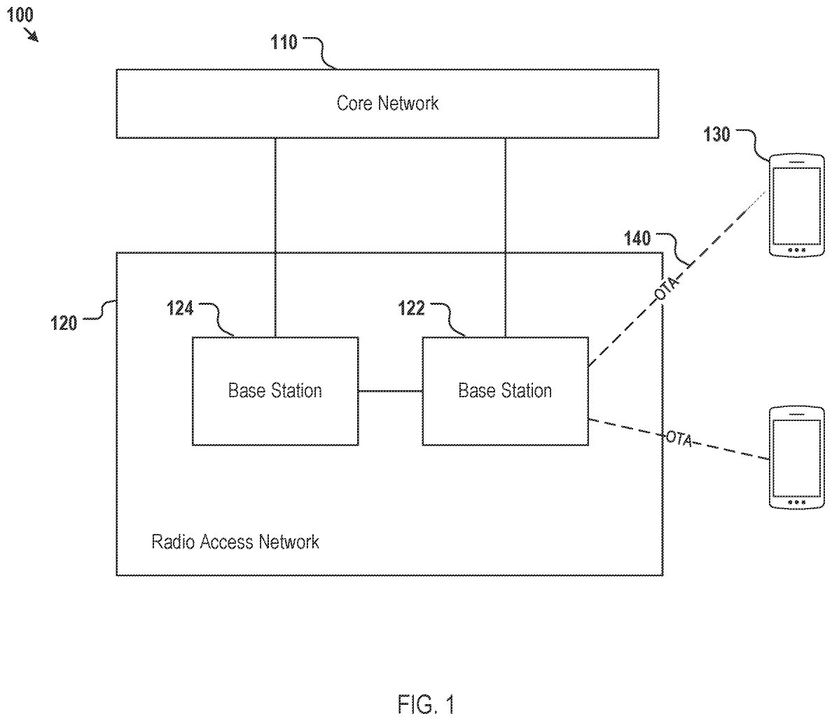

FIG. 1 shows an example cellular wireless communication network 100 (also referred to as wireless communication system) that includes a core network 110 and a radio access network (RAN) 120. The RAN 120 further includes multiple base stations 122 and 124. The base station 122 and user equipment (UE) 130 communicate with one another via Over the Air (OTA) radio communication resources 140. The wireless communication network 100 may be implemented as, as for example, a 2G, 3G, 4G/LTE, or 5G cellular communication network. Correspondingly, the base stations 122 and 124 may be implemented as a 2G base station, a 3G nodeB, an LTE eNB, or a 5G New Radio (NR) gNB. The UE 130 may be implemented as mobile or fixed communication devices installed with SIM/USIM modules for accessing the wireless communication network 100. The UE 130 may include but is not limited to mobile phones, Internet of Things (IoT) devices, Machine-type communications (MTC) devices, laptop computers, tablets, personal digital assistants, wearable devices, distributed remote sensor devices, roadside assistant equipment, and desktop computers. Alternative to the context of cellular wireless network, the RAN 120 and the principles described below may be implemented as other types of radio access networks, such as Wi-Fi, Bluetooth, ZigBee, and WiMax networks.

In the example wireless communication system 100 of FIG. 1 the UE 130 may connect with and establish a communication session with the base station 122 via the OTA interface 140. The communication session between the UE 130 and the base station 122 may utilize downlink (DL) and/or uplink (UL) transmission resources. The DL transmission resource carries data from the base station 122 to the UE 130, and the UL transmission resource carries data from the UE 130 to the base station 122.

### Small Data Transmission

In the wireless communication network, a user equipment (UE) may communicate in a small data transmission (SDT) mode. In legacy implementations, the transmission of user data is not allowed when in an inactive state. Even for the transmission of a very small amount of data, the UE needs transition to a connected state first, which may have a negative impact on system efficiency as a result of relatively heavy signaling overhead as well as device energy consumption. As described in the various implementations below, the transmission of small data payloads may be made instead in an inactive state of the UE. Under the prescription of the current new radio (NR) specifications, the UE may have three operational states: idle, inactive and connected. The UE cannot transmit data in idle and inactive states. When the UE needs to transmit data when it is in the idle or inactive state, the UE would first transition to the connected state. As described in the various example implementations below, for small data transmission (SDT), the UE may be configured to transmit small data in an inactive state, rather than having to transitioning to the connected state first.

Any device that has intermittent small data packets for transmission in an inactive state can benefit from the schemes described below for small data transmission (SDT) while in an inactive state. SDT traffic may have different service requirements as compared to that of conventional or larger data transmission types. SDT communication or data transfer may be made from/to the UE while in an inactive state. The UE may send an SDT request message to a base station, which may be, for example, a nodeB (e.g., an eNB or gNB) in a cellular mobile telecommunications context. The base station may respond to the UE request message with a reply that includes an SDT indication or acknowledgement. The SDT indication signals the UE that communication may be made from the UE even in an inactive state. Schemes of small data transmissions while in an inactive state facilitates reduction of power consumption and overall signaling overhead.

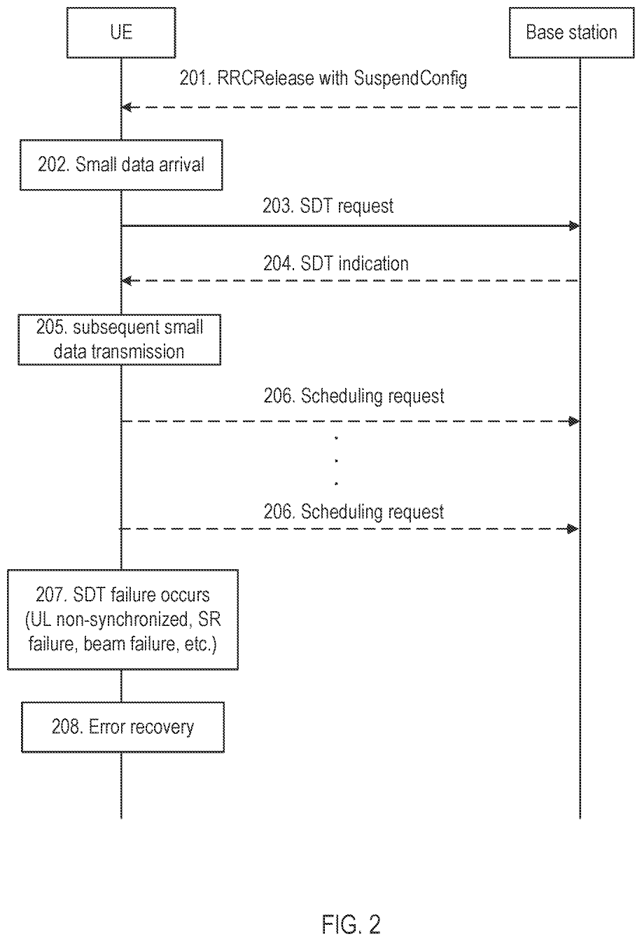

FIG. 2 shows an example small data transmission (SDT) procedure for a UE in an inactive state. FIG. 2 illustrates communication between the UE and a base station such as a gNB. As an example precondition, the UE transitions to inactive state in 201 upon receiving an RRCRelease message with SuspendConfig. As shown in 202, small data may arrives at the UE in the inactive state, which triggers the UE to initiate an SDT communication session (alternatively referred to as SDT session) by sending an SDT request to the base station at 203. The base station may acknowledge the SDT request at 204, and the SDT session may then be established. At step 205, the SDT session is considered to be established successfully and UE is ready for small data transmission. At step 206, the UE requests uplink (UL) resource by sending a scheduling request to the base station. The UL resource is used for subsequent UL data transmission. Based on the payload size, the UE may need to send multiple scheduling requests to acquire multiple UL resources. Alternatively, not shown in FIG. 2, rather than being request by the UE, the UL resource may be preconfigured, for example, by the base station. For example, the base station may schedule a periodic UL resource allocation for the UE. IF the UL resource is preconfigured, there would be no need for the UE to send the scheduling request.

Various different example mechanisms may be implemented for the UE to send the SDT request to the base station in step 203. The difference between the various mechanisms may include communication resource that the UE uses to send the SDT request to the base station. In one example scheme, when the UE is triggered to enter the inactive state by the RRCRelease message in step 201, the RRCRelease message may carry a preconfigured resource that the UE may use to send the SDT request. This scheme is referred to as a Configured Grant scheme (hereinafter called CG-scheme). In another scheme, rather than using a preconfigured resource, the UE uses common resource, such as a Random Access Channel (RACH) resource to send the SDT request. This scheme is referred to as a RACH scheme (hereinafter called RACH-scheme).

In the subsequent small data transmission, the UE may or may not need to send an SDT scheduling request. In some embodiments, if the SDT session is CG-based, then scheduling request for subsequent small data transmission may be required. In some embodiments, if the SDT session is RACH-based, preconfigured resource may be used for small data transmission without scheduling request.

Referring further to FIG. 2, the SDT session may encounter failure conditions 207 at various stages of the SDT session. The failure may be caused by poor signal coverage, resource limitation, and the like. Accordingly, the failure may be of various type. For example, there may be synchronization failure during the SDT session. Specifically, the synchronization between the UE and the base station may get lost (i.e., out of synchronization) during the SDT session, which may be indicated by a Timing Alignment (TA) timer expiration. For another example, there may be scheduling request failure. Such a scheduling request failure may impact subsequent small data transmission. For yet another example, a beam failure condition may occur. In presence any of these failure conditions, the UE may perform error recovery action 208. In this disclosure below, various embodiments are described for recovering from the aforementioned failure conditions. For example, in some implementations, a random access (RA) procedure may be invoked as part of the error recovery procedure while the UE is in inactive state. In some other implementations, a radio resource control (RRC) related procedure may be invoked.

As described above and in more detail below, the various SDT schemes enable a UE to transmit data in inactive mode. The various embodiments further improve on several other aspects of small data transmission, including but not limited to functions such as paging, System Information (SI) acquisition, Radio Access Network (RAN) based Notification Area Update (RNAU), and Discontinuous Reception (DRX).

### CG-Scheme: Scheduling Request Parameter Configuration

As described above, for an SDT session using a CG-scheme, a scheduling request (SR) may be needed to request UL data transmission resource. The SR is sent based on a specific SR configuration. The SR configuration may be sent to the UE from the base station, for example, by using an RRCRelease message with suspendConfig. In particular, the medium access control (MAC) entity of the UE may be configured with zero, one, or more SR configurations and each SR configuration corresponds to one or more logical channels.

The SR configuration may include parameters associated with dedicated SR resource. These parameters may include at least one of:
an SDT scheduling request identifier for identifying a scheduling request instance corresponding to an SDT session in a MAC layer of the wireless terminal;
a scheduling request prohibit timer for prohibiting sending an SDT scheduling request when the scheduling request prohibit timer is active (not expired); or
a maximum number of consecutive SDT scheduling request transmissions in one SDT scheduling request attempt (The SDT scheduling request transmissions include an initial transmission and subsequent re-transmission if the initial transmission fails. An SR failure occurs if the maximum number is reached).

Additionally, the SR configuration may further include parameters associated with the dedicated SR resource and further associated with dedicated physical uplink control channel (PUCCH) resource for the UE to send the SR. These parameters include at least one of:
an SDT scheduling request resource identifier for identifying an SDT scheduling request resource on the dedicated PUCCH resource;
an SDT scheduling request configuration identifier for identifying the first parameter set associated with the second parameter set.
an SDT scheduling request periodicity and offset in number of symbols, slots, or mini slots; or
a PUCCH resource identifier for identifying the dedicated PUCCH resource.

Additionally, the SR configuration may further include parameters associated with logical channel configured for the SDT session. These logical channel related parameters include at least one of an SDT scheduling request identifier associated with the SDT session.

### Random Access Procedure

As described above, a random access procedure may be used during the error recovery of an SDT session.

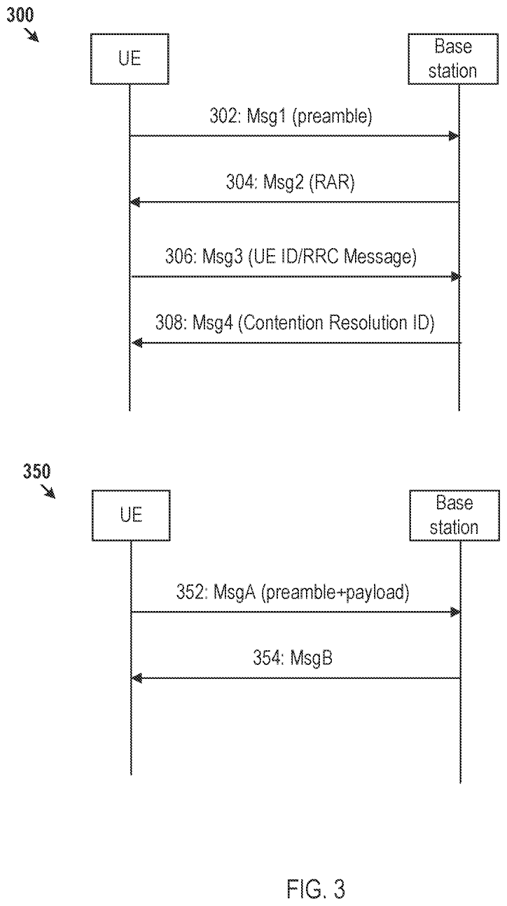

FIG. 3 shows example multi-step random access procedures 300 and 350. In various implementations, a UE and base station may engage in a multi-step protocol, where: (i) the UE send a preamble (e.g., in Msg1) to the base station (302), (ii) after reception of preamble, the base station sends back a random access response (RAR) (e.g., Msg2) to the UE (304), (iii) the UE sends to the base station a third message (e.g., Msg3) according to the UL grant indicated in the RAR containing the preamble transmitted in Msg1 (306), and (iv) after successfully decoding Msg3, a fourth message (e.g., Msg4) is transmitted from the base station to the UE for performing contention resolution (308). This example four-step random access channel (RACH) procedure 300 (alternatively referred to as 4-step RACH) may allow for establishment of RRC connections.

In some implementations, the latency created through the 4-step RACH procedure 300 may be reduced by using a two-step random access protocol 350 (alternatively referred to as a 2-step RACH). The 2-step RACH 350 may combine (i) and (iii) and combine (ii) and (iv) of the 4-step RACH procedure to condense the RACH procedure into two steps. The first step is to send a first message, e.g. MsgA (352). In some examples the first message may contain a preamble transmitted in physical random access channel and/or payload transmitted in physical uplink shared channel, which contains at least the same amount of information that is carried in Msg3 of 4-step RACH. A second message, e.g. MsgB in respond to MsgA is transmitted from the base station to the UE (354). The example 2-step RACH may help reduce communication latency compared to the 4-step RACH. Such a reduction of communication latency may further help, for example reduce channel occupancy times and increase data available for payload transmission. Accordingly, the 2-step RACH provides a technical solution to a network latency and other technical problem by increasing data network performance and improving the operation of network underlying hardware.

The 2-step and 4-step RACH described above may be contention based. In some other implementations, the base station informs the UE a preamble index to use for the random access, leading to a contention free RACH procedure.

In some implementations, the UE may choose to use different RACH resource to initiate the random access procedure for error recovery depending on the SDT scheme (i.e., CG-scheme or RACH-scheme). Under the CG-scheme, during the error recovery process, the UE may use the RACH resource in the same band width part (BWP) as the resource the UE uses to initiate the SDT session. In this scheme, the RACH resource may be preconfigured by an RRCRelease message. The RACH resource configuration may be combined or separate with suspendConfig in the RRCRelease message. Under the RACH-scheme, during the error recovery process, the UE may use common RACH resource for the random access procedure, which may be configured via System Information message.

### CG-Scheme Error Recovery: SR Failure

During an SDT session, if the transmission of a scheduling request fails at the UE (e.g., there is no reply being received from the base station), the scheduling request may be re-transmitted. When a number of consecutive scheduling request transmissions exceeds a preconfigured maximum number (e.g., as configured in the SR configuration parameter described above), an SR failure occurs. For error recovery purposes, the UE may initiate a random access procedure or enter an idle state as options.

### Option 1

During the SDT session, after detecting an SR failure, the UE may initiate a contention based random access procedure using the preconfigured RACH resource as described above. In particular, the RACH resource may be in the same BWP as the resource the UE uses to initiate the SDT session.

In some implementations, the random access procedure may be the 4-step RACH or the 2-step RACH.

In some implementations, a new MAC Control Element (CE), alternatively referred to as an I-RNTI (Inactive Radio Network Temporary Identifier) MAC CE, is introduced in the error recovery process. The I-RNTI MAC CE is associated with an I-RNTI which may be used by the network to identify the UE. The I-RNTI MAC CE may further be in two formats: a short format and a full size format. The short format I-RNTI MAC CE is associated with the short I-RNTI (e.g., 24 bits) of the MAC entity of the UE, and the full size format I-RNTI MAC CE is associated with the full I-RNTI (e.g., 40 bits) of the MAC entity of the UE.

For example, before the UE invokes the random access procedure, the MAC entity of the UE may notify the RRC layer of the UE to release the PUCCH resource allocated to the UE for the SDT session. After the UE completes the random access procedure, the base station may re-configure PUCCH parameters for the UE via an RRCRelease message, an RRCReconfiguration message, or the like.

In the random access procedure as invoked by the UE above, the Msg3/MsgA may include a C-RNTI MAC CE or an I-RNTI MAC CE to facilitate the base station or the network to identify the UE.

In these implementations, the random access procedure may be invoked when the UE is in an inactive state.

### Option 2:

Alternatively, during the SDT session and after detecting an SR failure, the MAC entity of the UE notifies the RRC layer of the UE to release dedicated resources associated with the SDT session. The UE then transitions to RRC idle state.

### Option 3:

Alternatively, during the SDT session and after detecting an SR failure, the MAC entity of the UE notifies the RRC layer of the UE to release dedicated resources associated with the SDT session. The UE then initiates an RRC re-establishment procedure.

### Option 4:

Alternatively, during the SDT session and after detecting an SR failure, the MAC entity of the UE notifies the RRC layer of the UE to release dedicated resources associated with the SDT session. The UE then initiates an RRC resume procedure.

The various options or embodiments above may be combined in various numbers and orders without limitation.

### CG-Scheme Error Recovery: Synchronization Failure

During an SDT session, it may be necessary to maintain timing alignment between the UE and the base station. A synchronization failure may occur during the SDT session and such failure may be indicated by an expiration of a Time Alignment (TA) timer.

In some implementations, the UE may choose to initiate a contention based random access procedure right after the detection of synchronization failure, or wait till there is UL data needs to be transmitted. This contention based random access procedure is similar to the random access procedure described in the section above for CG-scheme SR failure error recovery, and is not duplicated here.

In some implementations, the base station may order or request the UE to initiate a contention free random access or contention based random access via a PDCCH order upon DL data arrival. The PDCCH order may carry an indication whether the random access should be contention free or contention based. For example, if the ra-PreambleIndex has been explicitly provided by the PDCCH order, the UE may use a contention free procedure. Otherwise, a contention-based procedure may be used.

The random access procedure implementations above may be invoked when the UE is in an inactive state.

### CG-Scheme Error Recovery: Beam Failure

After a beam failure is detected during the SDT session, the UE may initiate a contention free random access procedure or contention based random access procedure to recover from the beam failure. The various implementation of the random access procedure is similar to the sections above.

In some implementations, the contention free random access may be preferred and may be invoked first and the contention based random access procedure may be used as a backup solution.

In these implementations, the random access procedure may be invoked when the UE is in an inactive state.

### RACH-Scheme Error Recovery: Synchronization Failure

During an SDT session, it may be necessary to maintain timing alignment between the UE and the base station. A synchronization failure may occur during the SDT session and such failure may be indicated by an expiration of a Time Alignment (TA) timer.

The UE may initiate a random access procedure to obtain uplink synchronization again. This random access procedure is similar to the random access procedure described in the section above for CG-scheme SR failure error recovery, except here the UE may use common RACH resource (e.g., RACH resource configured via system information message) to initiate the random access procedure.

The random access procedure in these implementations may be invoked when the UE is in an inactive state.

Paging with SDT

During an SDT session, the communication between the UE and network has been set up. As such, it is not necessary to send a paging Downlink Control Information (DCI) and a paging message associated with the paging DCI to a UE during the SDT session when the network needs to transmit DL data to the UE. Instead, the base station can directly send an RRC message, such as RRCResume, RRCSetup, and the like, to transition the UE to connected state. This implementation reduces signaling overhead, reduces latency, or may have other technical benefits compared with the paging approach.

In a certain condition, the UE may have just sent an SDT request to the base station to initiate an SDT session, but has not yet receives an acknowledgement from the base station. Before the SDT session is established successfully (e.g., after receiving an acknowledgement), if the UE receives a paging DCI (for paging message) and an associated paging message from the base station, the UE may stop the SDT procedure and initiate an RRC resume procedure.

For receiving system information modification, during the SDT, the UE may need to receive another type of paging DCI to obtain system information modification indication. It is to be understood that this other type of paging DCI is for system information modification and is different with the paging DCI for paging message referred to above. As such, the UE may be configured with a pagingSearchSpace that the UE uses when in an SDT session.

For SDT using CG-scheme, pagingSearchSpace parameters may be configured via RRCRelease message with suspendConfig in the same BWP as the resource the UE uses to initiate the SDT session. In particular, the pagingSearchSpace parameters may or may not be sent together with suspendConfig in the RRCRelease message.

For SDT using RACH-scheme, pagingSearchSpace parameters may be configured via system information on a common BWP.

### System Information

The system information (SI) provides critical information, such as physical resource information, cell measurement and selection/reselection associated information, etc., to the UE. There are two types of SIs depending on how the information is sent: broadcast SI and non-broadcast SI.

During an SDT session, the UE monitors for SI modification indication in its own paging occasion every DRX cycle. Upon receiving SI modification indication, the UE invokes the SI acquisition procedure from the start of the next modification period.

For non-broadcast SI and for a UE not in an SDT session, the UE may initiate random access procedure to acquire the non-broadcast SI. However, if the UE is in an SDT session, the communication between the UE and the network has been set up. As such, the UE may send an RRC message (e.g., a DedicatedSIBRequest message) to request the non-broadcast SI. The base station may respond with an RRCReconfiguration message carrying the requested non-broadcast SI. Alternatively, the base station may delivered the requested non-broadcast SI in a broadcast manner, for example, via an SI message. This implementation reduces extra procedure and signaling overhead, thereby improving the system performance and reducing UE power consumption.

### DRX

A UE may use DRX technology to reduce power consumption. When in an inactive state, the UE may monitor one paging occasion (PO) per DRX cycle. The DRX cycle of the UE may be determined by the shortest of the UE specific DRX value(s), if configured by RRC or upper layers, and a default DRX value broadcast in SI.

In some implementation, a UE may be configured with new DRX parameters dedicated for the UE when the UE is in an SDT session. For example, these new DRX parameters may be used to support UE's PDCCH monitoring activity for C-RNTI, CS-RNTI (Configured Scheduling RNTI), and the like. These new DRX parameters may be configured through an RRCRelease message.

In some implementation, an SDT specific searchspace value may be configured. In particular, a UE may be configured with a searchspace value longer than a predefined value, and this predefine value may be set and modified through an OAM (Operations, Administration and Maintenance) platform. For example, the searchspace value may be set to be equal to or longer than 2 milliseconds. A longer SDT specific searchspace value as disclosure herein helps the UE save energy during an SDT session.

### RAN Notification Area Update

A UE in inactive state may be tracked by the RAN for at least the reason that the RAN needs information as to how to page the UE. The UE may report its location related information by sending a periodic RAN Notification Area (RNA) update to the base station and this may be triggered by a T380 timer. During the SDT session, the communication between UE and the network has been set up. The various implementations below help reduce the overhead of the periodic RNA update.

In inactive state, upon initiating a SDT session, the UE may stop the T380 timer. Upon ending the SDT session, the UE may start the T380 timer again.

Additionally, the UE may be moving during the SDT session and it may move to another serving cell and the new serving cell may not belong to the configured RAN Notification Area of the UE. Furthermore, the new serving cell may or may not support SDT. As such:
if the new serving cell does not support SDT, the UE may end the SDT procedure and initiate an RRC connection resume procedure with resumeCause set to ma-Update;
if the new serving cell supports SDT, the UE may initiate a new SDT session by sending a SDT request which includes ma-Update indication to the base station.

### Data Arrival for Non-SDT Data Radio Bearer

The UE may be configured with Multi-Radio Dual Connectivity (MR-DC), using, for example an MCG (Master Cell Group) and an SCG (Secondary Cell Group). Depending on whether there is a logical channel configured in the MCG, there may be two types of Data Radio Bearers (DRB) which are configured not to be used for SDT (referred to as non-SDT DRB):
Non-SDT DRB with MCG path,
Non-SDT DRB without MCG path.

For the Non-SDT DRB with MCG path, the Buffer Status Report (BSR) may be used to inform the network about the UL data arrival on the UE side during an SDT session. However, for the Non-SDT DRB without MCG path, since there is no logical channel for the DRB in MCG, the buffer status for such a DRB will not be included in the BSR.

To detect the UL data arrival for Non-SDT DRB without MCG path during an SDT session, the following two options may be used:

### Option 1:

It is up to the network to ensure that no Non-SDT DRB without MCG path is configured for the SDT-enabled UE in inactive mode.

### Option 2:

The UE sends at least one of following information to inform the network to trigger state switching in case UL data is arrived for Non-SDT DRB without MCG:
a BSR with special value;
a new type of MAC CE; or
a new type of RRC message.

### Suppression of Packet Data Convergence Protocol (PDCP) Status Report

The receiving PDCP entity of the UE may trigger a PDCP status report when upper layer of the UE requests a PDCP entity re-establishment.

For the PDCP entity re-establishment triggered by the initialization of an SDT, or triggered by the RRC resume procedure, PDCP suspend procedure may be invoked which resets the RX_NEXT and RX_DELIV state variables to the initial value. As such, the PDCP status report triggered in this case may not provide any useful information to the network side.

Note: RX_NEXT is the state variable indicating the COUNT value of the next PDCP SDU (service data unit) expected to be received and RX_DELIV is the state variable indicating the COUNT value of the first PDCP SDU not delivered to the upper layers, but still waited for.

Therefore, to avoid a waste of resource, two options may be used:

### Option 1:

The PDCP status report needs not to be triggered by the PDCP entity re-establishment for the suspended PDCP (i.e. if the PDCP is suspended before the re-establishment, then PDCP status report is not be triggered).

### Option 2:

The UE may discard the PDCP status report triggered by the PDCP entity re-establishment for the suspended PDCP.

### RRC Reconfiguration Failure

During an SDT session, the UE may receive an RRC reconfiguration message. Upon an RRC connection reconfiguration failure during the SDT session, two options may be used for the UE to handle the failure:

### Option 1:

Upon an RRC connection reconfiguration failure during the SDT session, the UE may release the SDT session related dedicated resources and enters idle state.

### Option 2

Upon an RRC connection reconfiguration failure during the SDT session, the UE may release the SDT session related dedicated resources and then initiates an RRC re-establishment procedure.

### Integrity Check Failure

During an SDT session, the UE may configure its lower layers (such as PDCP layer) to apply Signaling Radio Bearer (SRB) integrity protection. During an SDT session, if integrity check failure indication is received from lower layers of the UE concerning SRB, UE has two options:

### Option 1:

Upon integrity check failure indication from lower layers concerning SRB during the SDT session, the UE may release the SDT session related dedicated resources and enter idle state.

### Option 2:

Upon integrity check failure indication from lower layers concerning SRB during the SDT session, the UE may release the SDT session related dedicated resources and initiate an RRC re-establishment procedure.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method performed by a wireless terminal in a wireless network, comprising:
receiving a first message from a wireless communication node in the wireless network comprising a random access channel configuration parameter; and
when the wireless terminal is in an inactive state, initiating an SDT session by sending an SDT initiation message to the wireless communication node on a preconfigured resource allocated by configured grant (CG).

2-8. (canceled)

9. The method of claim 1, further comprising:
detecting an SDT session failure condition; and
in response to the SDT session failure condition, initiating a random access procedure (RAP).

10. The method of claim 9, wherein the SDT session failure condition comprises a timing alignment failure with the wireless communication node.

11-12. (canceled)

13. The method of claim 9, wherein the first message further comprises a random access channel (RACH) configuration indicative of a random access channel resource, the RACH configuration being on the same BWP of the preconfigured resource allocated by configured grant.

14. The method of claim 9, wherein the random access procedure comprises a contention based random access procedure.

15. The method of claim 14, wherein:
the random access procedure comprises a Msg3 or a MsgA;
the Msg3 comprise a C-RNTI MAC CE (cell Radio Network Temporary Identifier MAC control element); and
the MsgA comprise a C-RNTI MAC CE.

16. (canceled)

17. The method of claim 1, further comprising:
detecting an SDT session failure condition; and
in response to the SDT session failure condition:
notifying by a MAC entity of the wireless terminal an RRC layer of the wireless terminal to release resource dedicated to the SDT session; and
transitioning to idle state.

18-22. (canceled)

23. A method performed by a wireless terminal in a wireless network, comprising:
when the wireless terminal is in inactive state, initiating an SDT session by sending an SDT initiation message to a wireless communication node in the wireless network on a RACH resource based on a random access procedure.

24. (canceled)

25. The method of claim 23, further comprising:
detecting an SDT session failure condition; and
in response to the SDT session failure condition, initiating a random access procedure (RAP).

26. The method of claim 25, wherein the SDT session failure condition comprises a timing alignment failure with the wireless communication node.

27-42. (canceled)

43. The method of claim 25, wherein the random access procedure comprises a contention based random access procedure.

44. The method of claim 43, wherein:
the random access procedure comprises a Msg3 or a MsgA;
the Msg3 comprises a C-RNTI MAC CE (cell Radio Network Temporary Identifier MAC control element); and
the MsgA comprises a C-RNTI MAC CE.

45. A wireless terminal comprising a memory for storing computer instructions and a processor in communication with the memory, wherein, when the processor executes the computer instructions, the processor is configured to cause the wireless terminal to:
receive a first message from a wireless communication node comprising a random access channel configuration parameter; and
when the wireless terminal is in an inactive state, initiate an SDT session by sending an SDT initiation message to the wireless communication node on a preconfigured resource allocated by configured grant (CG).

46. The wireless terminal of claim 45, further comprising:
detect an SDT session failure condition; and
in response to the SDT session failure condition, initiate a random access procedure (RAP).

47. The wireless terminal of claim 46, wherein the SDT session failure condition comprises a timing alignment failure with the wireless communication node.

48. The wireless terminal of claim 46, wherein the first message further comprises a random access channel (RACH) configuration indicative of a random access channel resource, the RACH configuration being on the same BWP of the preconfigured resource allocated by configured grant.

49. The wireless terminal of claim 46, wherein the random access procedure comprises a contention based random access procedure.

50. The wireless terminal of claim 49, wherein:
the random access procedure comprises a Msg3 or a MsgA;
the Msg3 comprise a C-RNTI MAC CE (cell Radio Network Temporary Identifier MAC control element); and
the MsgA comprise a C-RNTI MAC CE.

51. The wireless terminal of claim 45, wherein, when the processor executes the computer instructions, the processor is configured to further cause the wireless terminal to:
detect an SDT session failure condition; and
in response to the SDT session failure condition:
notify by a MAC entity of the wireless terminal an RRC layer of the wireless terminal to release resource dedicated to the SDT session; and
transition to idle state.

52. A wireless terminal comprising a memory for storing computer instructions and a processor in communication with the memory, wherein the processor, when executing the computer instructions, is configured to implement a method of claim 23.
